(19) United States
(12) Patent Application Publication
(10) Pub. No.: US 2026/0287839 A1
(43) Pub. Date: Sep. 24, 2026

(54) OPTICAL INTERCONNECT WITHIN 3D STACK OF WAFER SCALE COMPUTES

(71) Applicant: Eridu Corporation, Saratoga, CA (US)

(72) Inventors: Liang Wang, Newark, CA (US); Jerry A. Martinson, San Jose, CA (US)

(73) Assignee: Eridu Corporation, Saratoga, CA (US)

(21) Appl. No.: 19/086,574

(22) Filed: Mar. 21, 2025

(51) Int. Cl. G02B 6/43

(52) U.S. Cl. CPC G02B 6/43

(57) ABSTRACT

Consistent with an aspect of the present disclosure, an optical interconnect layer is provided that provides a high speed, low crosstalk optical connection between stacked wafer scale circuitry. The optical interconnect layer includes optoelectronic devices, such as LEDs on side and other optoelectronic devices, such as photodiodes, on the other side. Optical signals emitted by the LEDs may, in one example, be transmitted on optical fibers extending between the LEDs and photodiodes. In another example, light pipes including a transmissive material, such as polyimide, are embedded in a housing, and, in a further example, lenses are provided to focus light output by the LEDs onto the photodiodes. In an additional example, optical paths, such as optical fibers or light pipes, carrying the optical signals are included in conduits, whereby a coolant may be circulated between the conduits to thereby absorb heat generated by the wafer scale circuitry.

### BACKGROUND

The present disclosure relates to an apparatus that provides a connection between electronic components, such as wafer-scale circuitry.

### SUMMARY

Consistent with an aspect of the present disclosure, an apparatus is provided that comprises a substrate and a plurality of conduits provided in the substrate, each of which including a plurality of optical paths. The substrate is configured such that a space separates the plurality of conduits, wherein the space facilitates circulation of a coolant between the plurality of conduits. A first plurality of opto-electronic devices is provided, each of which being located at a first end of a respective one of the plurality of optical paths. In addition, a second plurality of opto-electronic devices, each of which being provided at a second end of a respective one of the plurality of optical paths, such that optical signals carrying data are transmitted via the plurality of optical paths.

### BRIEF DESCRIPTION OF THE DRAWINGS

FIG. 1 illustrates an example of a wafer scale stack including an optical interconnect layer consistent with an aspect of the present disclosure;

FIG. 2 illustrates an additional example of a wafer scale stack including an optical interconnect layer consistent with an aspect of the present disclosure;

FIG. 3 shows a further example of a wafer scale stack including an optical interconnect layer consistent with an aspect of the present disclosure;

FIG. 4 shows a detailed plan view of an optical interconnect layer consistent with the present disclosure;

FIGS. 5a and 5b show cross-sectional view of portions of the optical interconnect layer shown in FIG. 4;

FIG. 5c shows a cross-sectional view of another example of the optical interconnect layer;

FIGS. 6-12 show steps of a process for manufacturing an optical interconnect layer consistent with the present disclosure;

FIG. 13 shows an example of an optical fiber bundle consistent with an aspect of the present disclosure;

FIG. 14 shows a simplified perspective view of arrays of optoelectronic devices consistent with the present disclosure;

FIG. 15 shows optical connections or paths within optical interconnect layer consistent with an aspect of the present disclosure; and

FIG. 16 shows an example of driver circuitry consistent with an additional aspect of the present disclosure.

### DETAILED DESCRIPTION

The following detailed description of example implementations refers to the accompanying drawings. The same reference numbers in different drawings may identify the same or similar elements.

Generative artificial intelligence (“AI”) has created a need for expanded computational capacity. Accordingly, various semiconductor technologies, including packaging, are being explored to provide greater computational performance. For example, wafer-scale computing, as opposed to die-scale, is currently being investigated to achieve such performance. Moreover, three-dimensional (3D) stacking techniques are being considered to optimize computing efficiency and throughput. Namely, such stacking involves providing two or more device layers, one on top of the other, wherein each layer includes a wafer or a reconstituted wafer formed of chiplets. Such 3D wafer scale stacked architectures, however, require high bandwidth interconnects that exhibit low latency and minimal power consumption.

Hybrid bonding techniques have been employed to provide local interconnects having relatively low latency and power consumption. Hybrid bonding, however, is not suitable for relatively long reach interconnects within the same layer or between layers.

Further, silicon microchannel TSV (“through silicon via”) interposers are known which have channels formed therein through which a coolant may be circulated to regulate the temperature of layers provided above and beneath the interposer. However, the TSV density in such interposers is relatively low, because the TSV aspect ratio is approximately 10:1 and the area available for TSVs is limited after the microchannels have been formed. Accordingly, although silicon microchannel TSV interposers may facilitate cooling, such interposers may not be used in connection with hybrid bonding.

Some implementations described herein provide an optical interconnect layer for optical connection within a 3D stack of wafer-scale computes. For example, the optical interconnect layer may comprise a substrate with a plurality of conduits or channels formed therethrough, each containing a plurality of optical paths separated by a space configured to allow coolant circulation. A first plurality of opto-electronic devices is provided at one end of each optical path, and a second plurality of opto-electronic devices is located at the opposite end of the optical path, enabling the transmission of optical signals carrying data between the first and second pluralities of opto-electronic devices provided on opposite sides of the substrate. In some aspects, integrated circuitry or chiplets are provided on opposing side surfaces of the substrate and electrically coupled to the opto-electronic devices. In one example, the optical paths may include optical fibers that extend between the opto-electronic devices. The fibers may be provided in conduits, whereby a coolant circulates between the conduits thereby cooling and regulate a temperature of the chiplets. In another example, light pipes, instead of fibers, are provided in which optical signals are transmitted through openings in a housing, whereby sidewalls of each opening are coated with a reflective material to minimize absorption or loss. The opto-electronic devices may include optical sources, such as light emitting diodes (LEDs), and photodiodes, such that the LEDs are controlled to output modulated optical signals based on the data carrying electrical signals supplied by the chiplets. In a further example, the LEDs are controlled by a control circuit including transistors, such as MOS transistors, to modulate the optical signals.

The optical interconnect consistent layer with the present disclosure operates at relatively low power, provides a fast transmission speed with a relatively low RC delay, and transmits optical signals without interference caused by crosstalk.

In one example, a relatively simple modulation format, such as on-off-keying (OOK) may be employed, such that transmission of ‘1’ bit is represented by turning on the LED, which may be a micro LED, and transmission of a ‘0’ bit is represented by turning off the LED. If micro-LEDs are employed, each micro-LED pixel may independently occupy an area of 5 μm². Small dies of micro-LED arrays may be bonded to multiple sites on one device layer of the 3D stack. Dies including photodetector arrays may also be employed.

In a further example noted above, light beams or optical signals output from micro-LED array are transmitted through small-size passages or vertical pipes (“light pipes”) through the microchannel cooling interposer and received at the photodetector array die bonded to the other device layer of the 3D stack.

Moreover, optical waveguides can be fabricated horizontally for long-reach interconnect between the micro-LED and photodetector arrays (either within the same layer of wafer-scale compute or between layers, as well as with or without microchannel cooling interposer wafer).

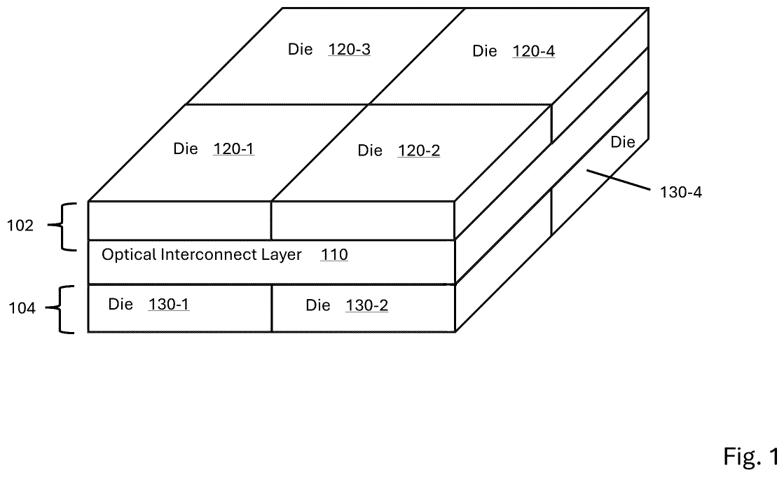

Examples of wafer scale circuitry including an optical interconnect layer consistent with the present disclosure will next be described with reference to FIGS. 1-3.

FIG. 1 depicts module 100 including a first device layer 102 including chiplets or dies 120-1 to 120-4 provided on a first side of optical interconnect interposer or optical interconnect layer 110, and a second device layer 104, including die or chips 130-1, 130-2, 130-3 (not shown), and 130-4, provided on a second side of layer 110 opposite the first side.

Chiplets 120 and 130 may include integrated circuitry, such as processing circuits, switching devices, or graphics processing units (GPUs) and are capable of performing various high-speed computing tasks typical of wafer-scale computes.

As described in greater detail below, optical interconnect layer 110 includes light-emitting diodes (LEDs), which are controlled to transmit modulated optical signals vertical pathways to photodetector arrays at an opposite end of each pathway.

Additionally, while the optical interconnect layer 110 is shown as providing vertical communication between chiplets in device layers 102 and 104, horizontal optical waveguides can also be implemented for inter-chip communication over longer distances within the same wafer-scale compute layer, e.g., within layer 102 or within layer 104.

As indicated above, FIG. 1 is provided as an example. Other examples may differ from what is described with regard to FIG. 1.

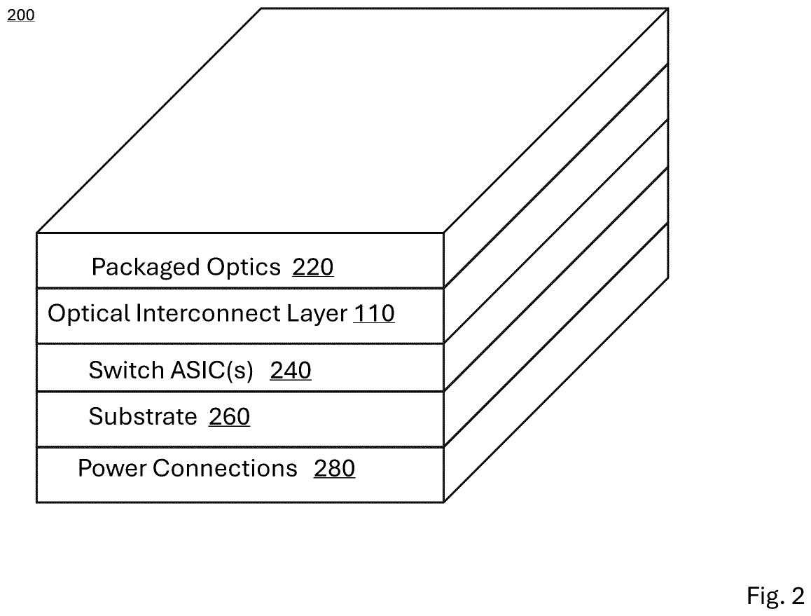

For example, FIG. 2 depicts an example of another module 200 for optical interconnection within a 3D stack of wafer scale computes or wafer scale circuitry. Apparatus 200 comprises multiple layers, with various components situated in a tiered or stacked configuration.

The base or lowermost layer of the structure includes power connections 280, which supply electrical power to various components of the module 200, to thereby facilitate operation of module 200.

As further shown in FIG. 2, substrate 260 is provided on power connection layer 280, and layer 240 is provided on substrate 260. In one example, layer 240 includes one or more switch application specific integrated circuits (ASICs), which are operable to route or switch data in connection with high-speed computing tasks. In one example, switch ASIC(s) included in layer 240 are powered by way of power connections extending from layer 280 beneath substrate 260.

Optical interconnect layer 110 noted above is provided on layer 240. Additional details concerning optical interconnect layer 110 are discussed below. Layer 220 includes packaged optics and is provided on optical interconnect layer 110. Such packaged optics includes transmitters and receivers coupled to the devices in layer 110 to transmit/receive optical signals via optical fibers extending from layer 220.

As indicated above, FIG. 2 is provided as an example. Other examples may differ from what is described with regard to FIG. 2. The number and arrangement of components shown in FIG. 2 are provided as an example. In practice, there may be additional components, fewer components, different components, or differently arranged components than those shown in FIG. 2.

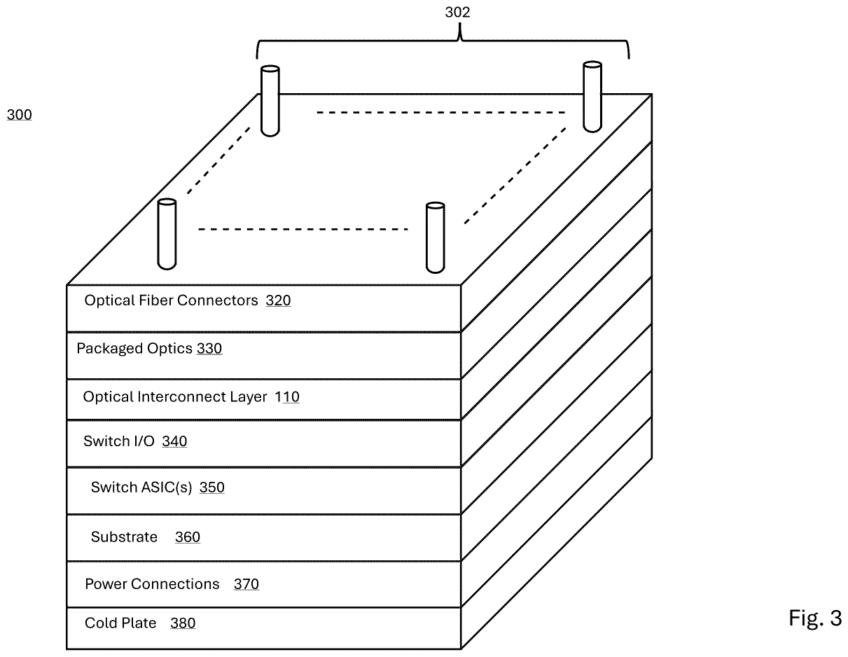

FIG. 3 depicts an apparatus 300 similar to apparatus 200 discussed above in connection with FIG. 2. For example, apparatus 300 includes power connections 370, substrate 360, switch ASIC layer 350, optical interconnect layer 110, and packaged optics 330 corresponding to power connections 280, substrate 260, switch ASIC layer 350, optical interconnect layer 110, and packaged optics 220, respectively, shown in FIG. 2. FIG. 3, however, further shows cold plate 380, beneath power connection layer 370, that regulates a temperature of apparatus 300. In addition, a switch input/output “I/O” layer is provided between switch ASICs 350 and optical interconnect layer to provide signals to and receive signals from optical interconnect layer 110. Moreover, optical fibers 302 are shown coupled to optical fiber connectors 320 to thereby transmit optical signals form and provide optical signals to packaged optics 330.

As indicated above, FIG. 3 is provided as an example. Other examples may differ from what is described with regard to FIG. 3. The number and arrangement of components and layers shown in FIG. 3 are provided as an example. In practice, there may be additional components and layers, fewer components and layers, different components, or differently arranged components and layers than those shown in FIG. 3.

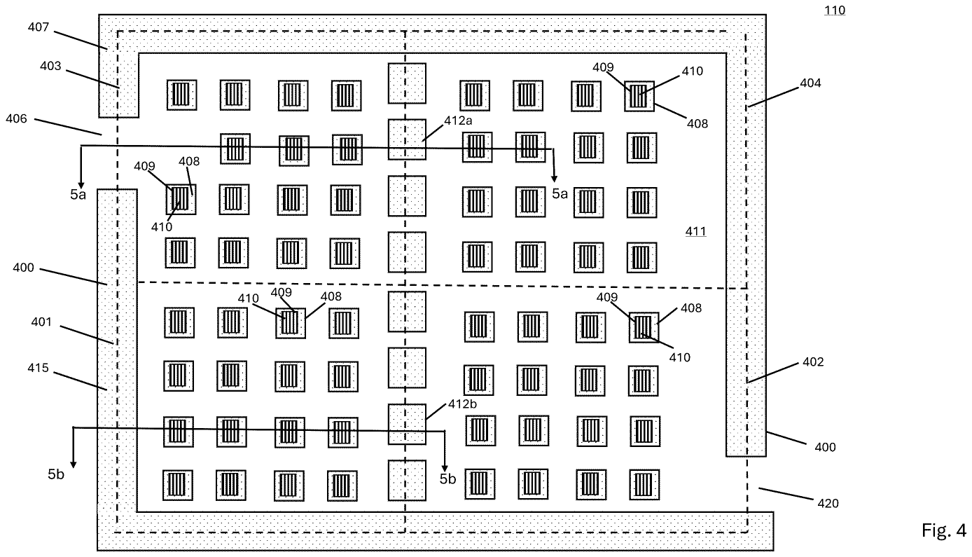

An example of an interconnect layer consistent with the present disclosure will next be described with reference to FIG. 4.

FIG. 4 depicts a plan view of optical interconnect layer 110 in greater detail. Optical interconnect 110 comprises a substrate 400, which includes a cavity 411. Pillars, such as 412a and 412b, are provided for structural support of interconnect layer 110. In one example, pillars 412a and 412b are portions of substrate 400 that extend into cavity 411 from the bottom of substrate 400 to the top of substrate 400. Additional substrate portions, such as portions 407 and 415 of substrate 400, extend along the periphery of cavity 411 to thereby provide additional structural support. Moreover, an array of conduits 409 in substrate body portions 408, also extend from the bottom of substrate 400 to the top of substrate 400. Fibers 410 are provided in each conduit to facilitate optical transmission in the conduits, as described in greater detail below.

As further shown in FIG. 4, gaps are provided between portions 407 and 415. The first gap constitutes an inlet 406 for receiving a liquid coolant, such as water, and the second gap constitutes an outlet 420 for the liquid coolant to exit cavity 411 after the coolant has circulated between the pillars 412 and conduit body portions 408. The coolant, in one example, is operable to absorb heat generated by chiplets, die, or integrated circuits such as die 120 and 130 provided above and/or below optical interconnect layer 110 in FIG. 1. In a further example, conduits 409 constitute an air-filled space. Thus, the pillars and substrate body portions are configured to facilitate circulation of a coolant, such as water, between the pillars and body portions to facilitate cooling of the integrated circuits or die, as noted above.

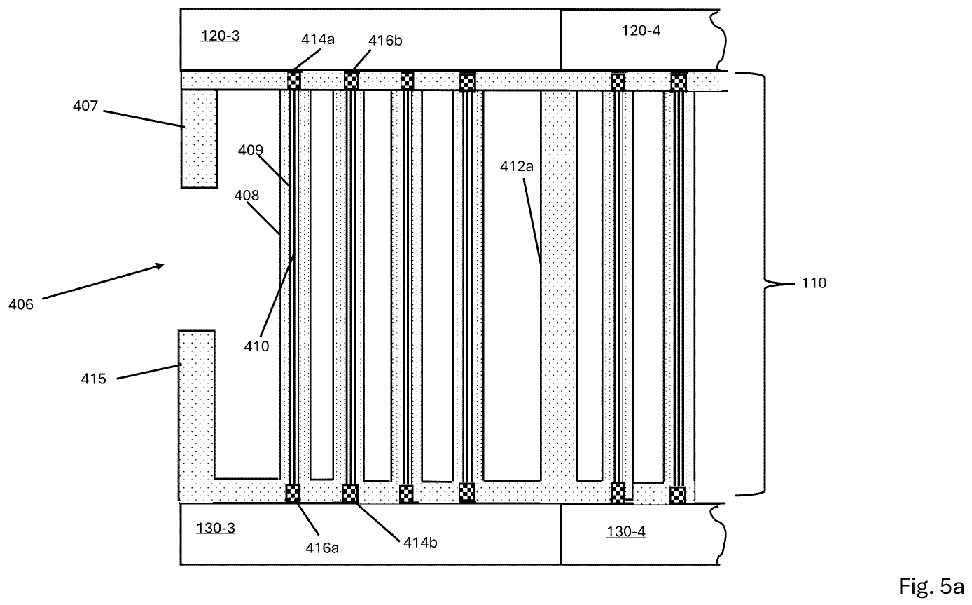

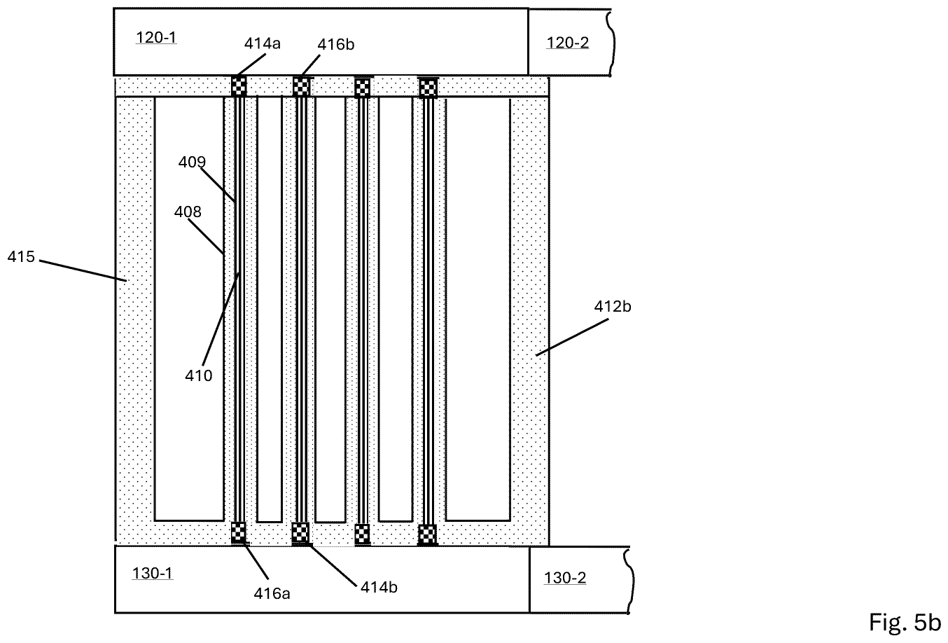

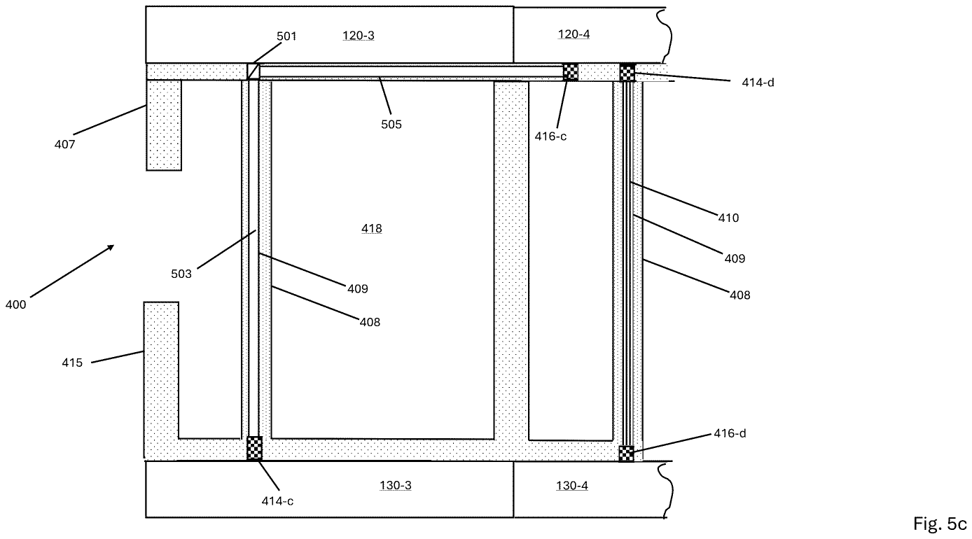

Put another way, body portions 408 are spaced from one another in cavity 411 within the substrate 400, and each body portion 408 includes a corresponding one of a plurality conduits 409. In one example, conduits 409 include optical paths or optical waveguides, such as fiber bundles 410, that extend from opto-electronic devices, such as light emitting diodes (LEDs) 414 at one end of each such optical path, and opto-electronic devices, such as photodiodes 416, at the other end of each optical path. As a result, optical signals carrying data output from the LEDs 414 are transmitted via the plurality of optical paths, e.g., fiber bundles 410, to photodiodes 416. As further shown in FIGS. 5a and 5b, conduits 409 extend between opto-electronic devices, such as LEDs or micro-LEDs 414 and additional opto-electronic devices, such as photodiodes 416.

Dashed lines 401 to 404 in FIG. 4 indicate locations of die 120-1 to 120-4 above substrate 400.

FIG. 5 a shows a cross-sectional view interconnect layer 110 take along line 5a-5a in FIG. 4. As shown in FIG. 5a, substrate 400 is provided between die 120-3 and die 130-3. Substrate 400 includes body portions 408 that extend from die 120-3 to die 130-3. A conduit 409 is included in each substrate body portion 408 through which optical fiber groupings or bundles 410 are provided in one example. Light emitting diodes (LEDs) 414a/414b, in a further example, are provided at one end of the optical fibers and photodiodes 416a/416b are provided at the other end of the fiber bundles 410 to receive modulated optical signals output from the LEDs 414. In a further example, the LEDs are micro-LEDs. In this example, the optical fibers constitute optical paths that extend across the width of substrate 400 between die 120-3 and die 130-3.

Pillars, such as pillar 412a, provide structural support for optical interconnect layer 110. Further support is provided by substrate portions 407 and 415, which, as noted above, extend along the periphery of optical interconnect layer 110. As further noted above, an opening or inlet 406 is provided between a part of substrate portion 407 and substrate portion 415 for receiving a coolant. The coolant may circulate between the substrate body portions 408 and pillars 412. Given the proximity of the coolant to die 120 and 130, heat generated by such die may be absorbed by the coolant to thereby cool and regulate a temperature of the die and thus facilitate proper operation of circuitry integrated on the die.

In one example, each of substrate portions 407, 415, body portions 408, and pillars 412 are formed from the same material, and, as described in detail below, etched from a common substrate, such as substrate 400.

In one example, integrated circuitry included in the die (e.g., die 120-3) provides electrical signals carrying data to a driver circuits, which, in turn, drive LEDs 414 to provide corresponding modulated signals, which also carry the data. As noted above, the modulated optical signals are sensed or detected by photodiodes 416 following transmission through individual fibers included in optical fibers bundles 410. In response to the transmitted optical signals, the photodiodes generate additional electrical signals, which are supplied to die on the opposite side of substrate 400 (e.g., die 130-3), such that data transmitted by die 120-3 is received by die 130-3.

In one example, each optical signal is transmitted through a corresponding optical fiber in a corresponding conduit 409. Accordingly, the optical signals are isolated from one another, thereby reducing crosstalk. Moreover, latency is reduced through optical transmission instead of transmission of electrical signals.

Additionally, the apparatus supports long-reach optical waveguide interconnects for horizontal communication between micro-LED and photodetector arrays within the same layer, thus simplifying the implementation of a high-bandwidth and low-latency interconnect system.

FIG. 5b shows another cross-sectional of optical interconnect layer 110 taken along line 5b-5b extending from substrate portion 415 through pillar 412b. Body portions 408, conduits 409, fibers and/or fiber bundles 410, LEDs 414, and photodiodes 416 are similar to those described above in connection with FIG. 5b. In FIG. 5b, however, connections are shown between die 120-1 and 130-1 instead of connection between dies 120-3 and 130-3, as discussed above in regard to FIG. 5a.

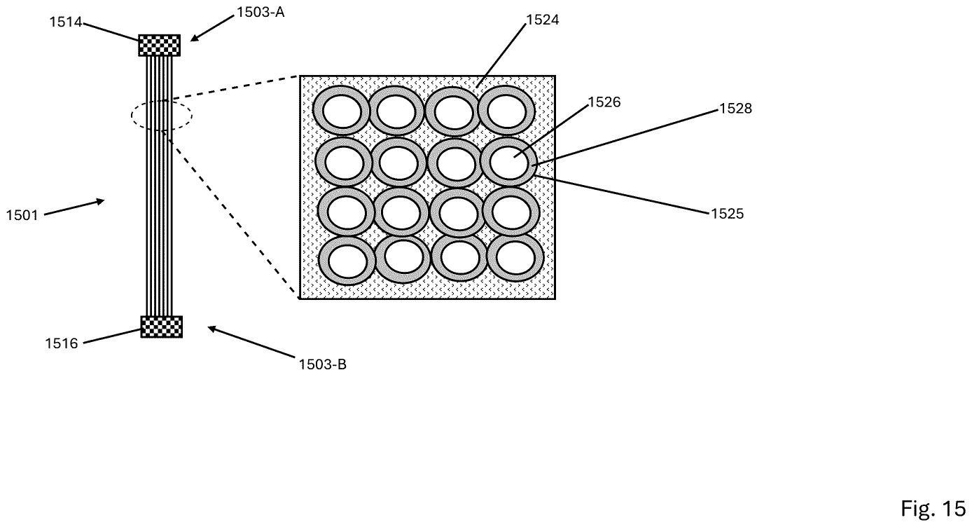

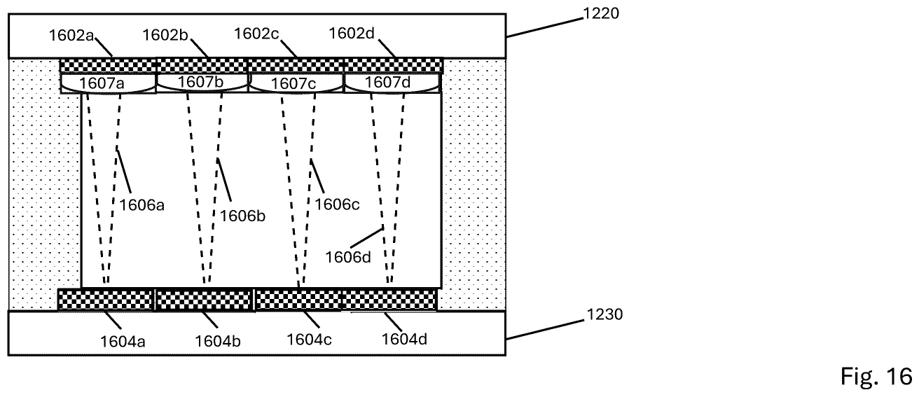

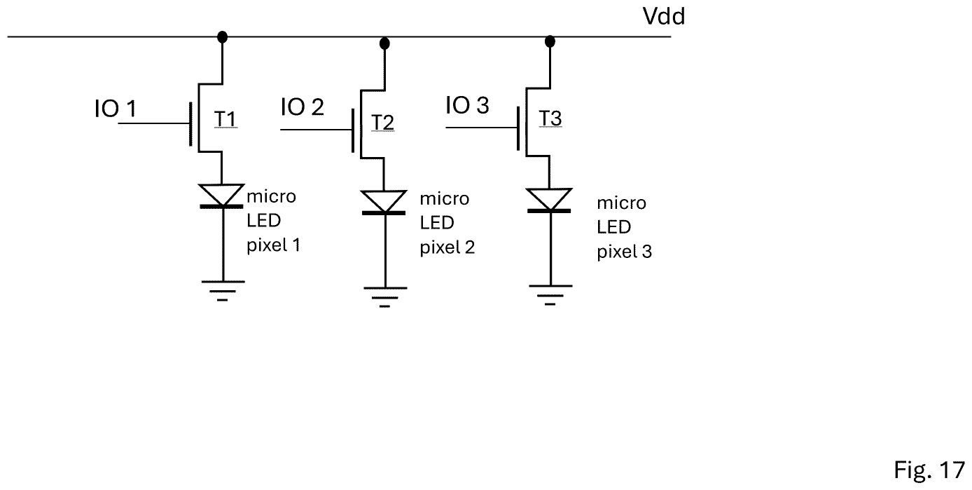

FIG. 5c shows another example of optical interconnect layer 110, whereby optical signals may be transmitted to die or integrated circuits other than those directly above the LEDs, such as that shown in FIGS. 5a and 5b. That is, it is contemplated herein that optical signals may be transmitted to any die in device layer 104, as described below. Namely, and by way of example as shown in FIG. 5c, one of conduits 409 includes a first optical path or waveguide 503 that extends from LEDs 414c to mirror 501. An additional optical path waveguide 505 is also provided that extends from mirror 501 to photodiodes 416-c. Accordingly, optical signals output from photodiodes 414-c based on electrical signals supplied by integrated circuitry on die 130-3 propagate along waveguide 503, are reflected by mirror 501, and are directed along optical path or waveguide 505 to photodiodes 416-c. Photodiodes 416-c, in turn, convert the optical signals into corresponding electrical signals that are fed to integrated circuitry on die 120-4. Waveguides 503 and 505 may include one or more optical fibers or include features that otherwise facilitate optical transmission, such as those described below with reference to FIGS. 15 and 16.

Consistent with a further aspect of the present disclosure, waveguide 505 or other waveguides may extend laterally relative to waveguide 503, for example, to photodiodes beneath other die instead of die 120-4 and thus provide corresponding electrical signals to such die for further processing. In addition, die 120-4 or other such die, may include circuitry to provide further electrical signals, based on the electrical signals output from photodiodes 416-c to other LEDs, such as LEDs 414-d, which may then provide further optical signals to photodiodes electrically coupled to integrated circuits or die, such as die 130-4, in device layer 104.

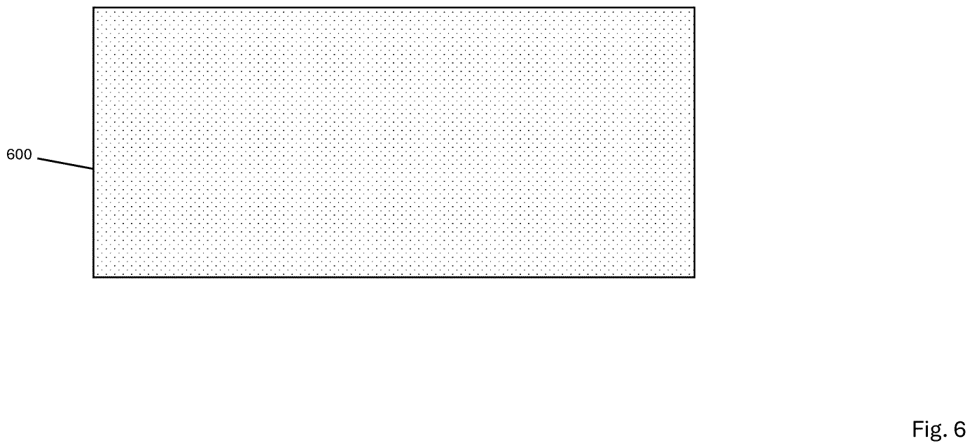

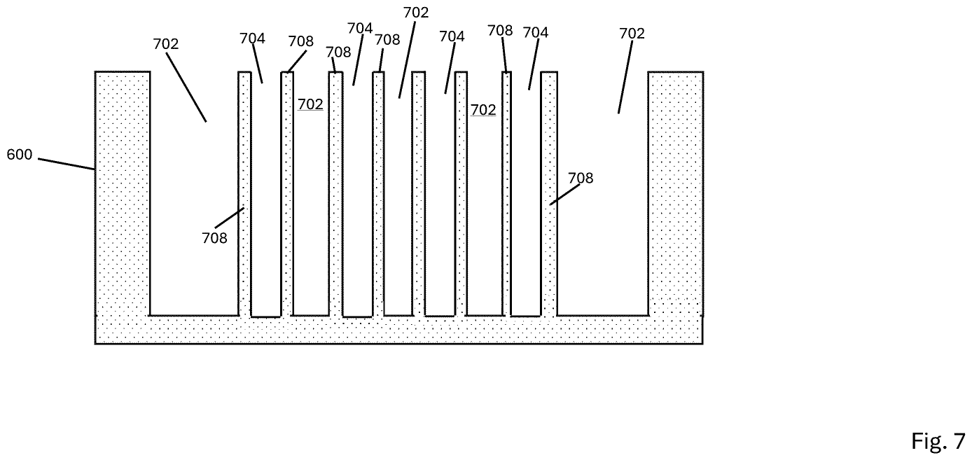

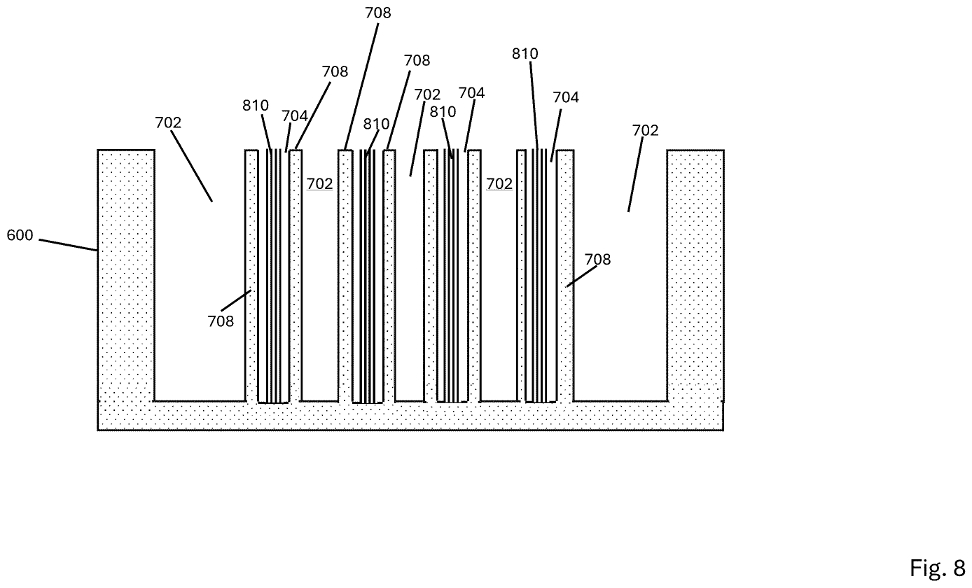

An example of a method for manufacturing an optical interconnect layer consistent with the present disclosure will next be described with reference to FIGS. 6-12. As shown in FIG. 6, substrate 600 is obtained, which may include silicon, for example. As shown in FIG. 7, substrate 600 is etched to form cavities or voids 702, as well as openings or holes 704 to thereby form substate body portions 708, and, in a subsequent step shown in FIG. 8, one or more optical fibers 810 are provided in each of holes or openings 704.

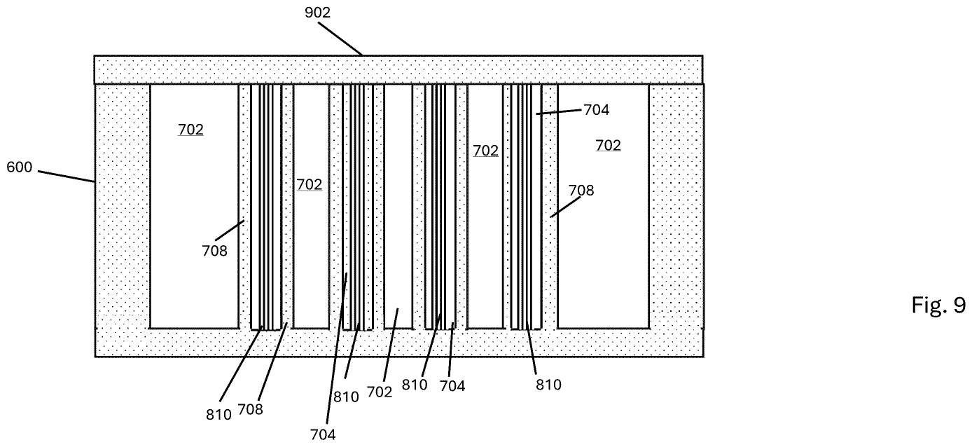

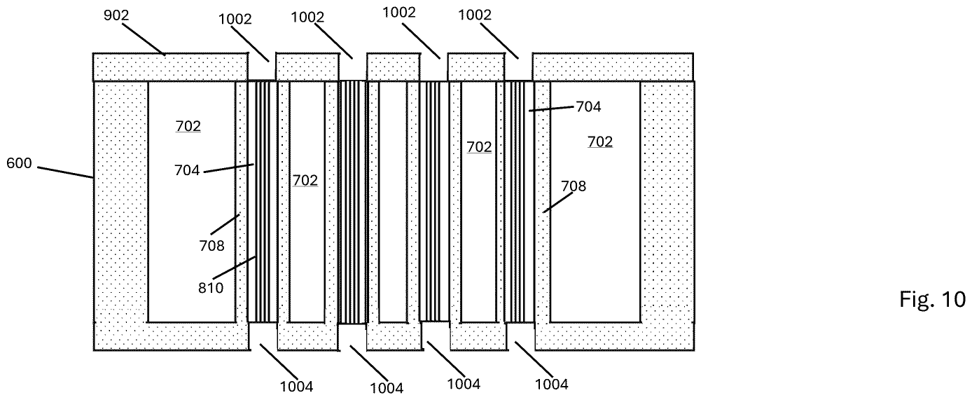

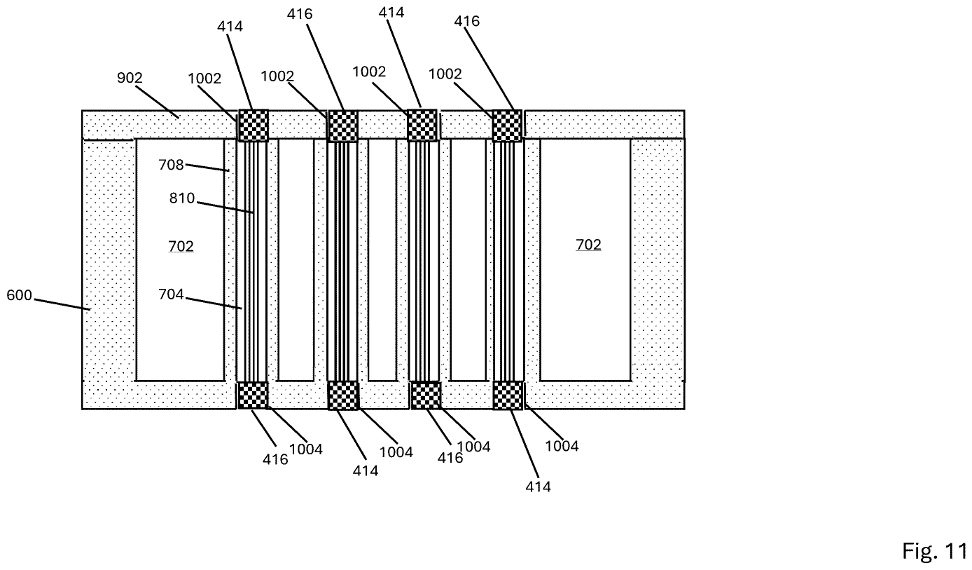

In FIG. 9, a second substrate 902, which may also include silicon, is provided over cavities or voids 702, holes or openings 704, and first ends of fibers 810. In FIG. 10, second substrate 902 is then selectively etched to form openings 1002, for example, to expose the first end of fibers 810, and openings 1004 are formed by etching substrate 600 beneath holes 704 to thereby expose second ends of fibers 810. Next, optoelectronic devices, such as LEDs, preferably micro-LEDs, are provided in selected openings 902 and 1002. In addition, other optoelectronic devices, such as photodiodes, are provided in remaining openings 902 and 1002 that are opposite the openings in which the LEDs are provided (FIG. 11). Thus, in one example, each fiber 810 has a light emitting LED 414 provided at one end and a photodiode 416 at the other end to facilitate transmission and reception of optical signals through optical interconnect layer 110.

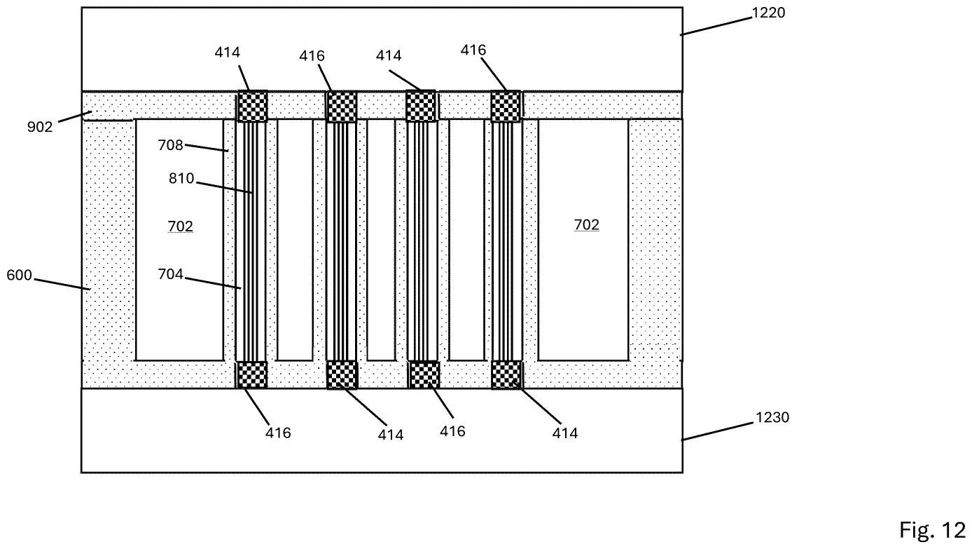

In a further steps, as shown in FIG. 11, die 1220 is provided, in one example, in contact with and bonded to substrate 902. In addition, electrical circuitry on die 1220 is provided in electrical contact with LEDs 414 and photodiodes 416 provided in openings in substrate 902. Moreover, die 1230 is provided in contact with and bonded to substrate 600. Further, electrical circuitry on die 1220 is provided in electrical contact with LEDs 414 and photodiodes 416 provided in openings in substate 600, as shown in FIG. 12. When assembled or bonded to one another as shown in FIG. 12, substrates 600 and 902 collectively constitute a substrate consistent with an aspect of the present disclosure.

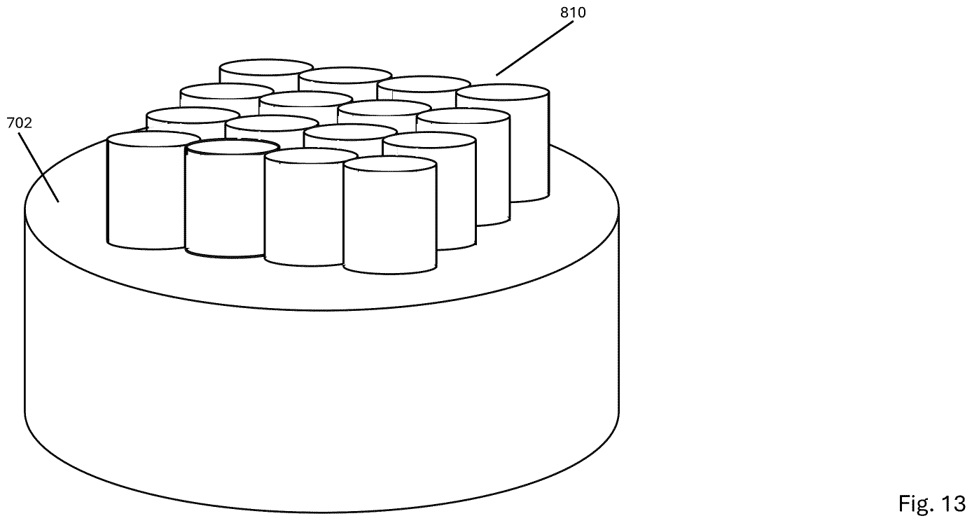

FIG. 13 shows an example of an optical fiber bundle provided in opening 702. In this example 16 optical fibers are included in the bundle. It is understood, however, that more or fewer optical fibers may be included in the bundle. Alternatively, a single optical fiber may be provided in each opening 702.

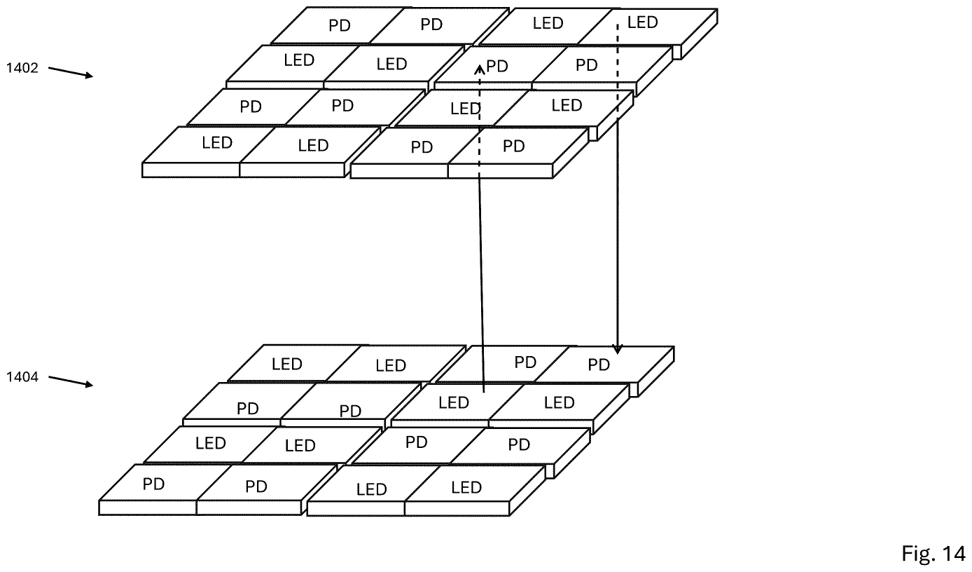

FIG. 14 shows a simplified perspective view of a first array of optoelectronic devices 1402 including LEDs and photodiodes, which may be provided in an opening in substrate 902. FIG. 14 also shows a second array of optoelectronic devices 1404 including LEDs and photodiodes, which may be provided in an opening in substrate 600. In one example, each LED in array 1402 is aligned with and supplies optical signals to a corresponding photodiode in array 1404 via an optical fiber (not shown in FIG. 14). In addition, each LED in array 1404 is aligned with and supplies optical signals to a corresponding photodiode in array 1402 via an optical fiber.

In a further example, each LED constitutes a pixel of arrays 1402 and 1404. Moreover, each LED may be controlled independently to emit light when an electrical signal corresponding to “1” is received or to remain off or at a low power level when the signal is “0,” facilitating efficient optical signal modulation and data transmission, as noted above.

In the above examples, optical fibers carry optical signals output from the LEDs to the photodiodes. In a further example, however, the optical fibers are replaced by a photo-imageable housing material embedded with light pipes including a transparent filling inner portion and a reflective outer portion, as described in greater detail below with reference to FIG. 15.

As shown in FIG. 15, optical connections or paths within optical interconnect layer 110 may each, in one example, be a prefabricated light pipe 1501, which may be placed in each hole or opening 704. As further shown in FIG. 15, light pipe 1501 includes optoelectronic devices, such as LEDs or micro-LEDs, 1514 at one end 1503-A, and additional optoelectronic devices, such as photodiodes at the other end 1503-B.

A housing or filler material 1524 is provided between optoelectronic devices 1514 and 1516. In one example, filler material 1524 is photo-imageable such that material 1524 may be patterned in a photolithography process to create openings 1525. The photo-imageable material or epoxy may be, for example, SU-8, commercially available from Kayaku Advanced Materials, Inc. of Boston, MA. In a further example, an inner surface or sidewall of each of openings 1525 is sputtered or otherwise coated with a reflective metal 1528, such as silver. Moreover, an outer layer including a magnetic material, such as nickel, may also be added to assist in alignment and assembly.

As further shown in FIG. 15, a transparent filler 1526 may be provided within a space within each opening 1525 after the reflective metal has been deposited. Such transparent filler may be, for example, polyimide, or other material that supports transmission of optical signal through the light pipe 1501.

In operation, electro-optic device 1514, e.g., LEDs, generates light signals based on electrical signals supplied by dies 1220 or 1230, for example, which propagate through the transmissive material 1526. Reflective coatings 1528 minimize absorption by the sidewall of opening 1525 during such transmission. The optical signals are thus directed to electro-optic device 1516, e.g., photodiodes, with minimal loss.

In a further example, the housing includes silicon which may be etched to provide opening 1525, which may be clad with, for example, polyimide or silicon dioxide (SiO₂) to guide light therethrough.

FIG. 16 shows another example of optical interconnect layer 110 consistent with a further aspect of the present disclosure. As shown in FIG. 16, a plurality of light emitting diodes (LEDs), e.g., micro-LEDs, 1602a, 1602b, 1602c, and 1602d, are provided adjacent first die 1220 to thereby receive, for example, drive signals from integrated circuitry provided on the die. Each LED is operable to generate a corresponding one of modulated optical signals 1606a, 1606b, 1606c, and 1606d based on such drive signals, which represent binary data. The terms die, integrated circuit, and chiplet are used interchangeably herein.

The modulated optical signals 1606a to 1606d are transmitted through respective lenses 1607a to 1607d, each corresponding to one of LEDs 1602a to 1602d. The lenses are operable to focus the optical signals emitted from the LEDs (which have a Lambertian angular distribution), thereby reducing crosstalk and ensuring that the optical signals are directed towards photodiodes 1604a to 1604d. The photodiodes are positioned on a second die 1230 and serve as receivers for the optical signals, to thereby convert the received optical signals into corresponding electrical signals, which are supplied to circuitry on die 1230 for further processing.

Consistent with the present disclosure, the example shown in FIG. 16 omits optical fibers or light pipes for directing optical signals from the LEDs to the photodiodes. As such, there is no need for an additional processing step of aligning such fibers or light pipes between the LEDs and photodiodes.

In the above examples, optical interconnect layer 110 may be hybrid bonded onto the top and bottom die, such as die 1220 and 1230. The LEDs and photodiodes may also be provided on separate die, which may be flip chip bonded to die 1220 and 1230.

FIG. 17 illustrates an example of a control circuit, such as LED driver circuitry 1700, consistent with a further aspect of the present disclosure. Here, input signals IO1 to IO3, are supplied from integrated circuitry on die 1220, for example, and each is supplied to a corresponding gate electrode of transistors T1 to T3. Moreover, in the example shown in FIG. 17, transistors T1 to T3 are n-channel metal-oxide-semiconductor field effect transistors (MOSFETs), each having a drain electrode coupled to power supply Vdd, and a source electrode, coupled via a respective one of LEDs 1 to 3, e.g., micro-LEDs, to ground. Accordingly, when input IO1, for example, is at a relatively high voltage, transistor T1 turns “on” and conducts, such that a voltage substantially equal to Vdd is applied across micro-LED 1, thereby causing LED 1 to emit light representing a “1” bit, for example. When input voltage IO1 is at a relatively low voltage, transistor T1 is turned “off,” thereby disconnecting LED 1 from power supply Vdd, such that LED 1 does not emit light or emits light at significantly less power than when transistor T1 is turned “on.” When transistor T1 is “off,” therefore, the reduced optical power associated with LED 1 may be representative of a “0” bit, for example.

Consistent with the present disclosure, the driver circuitry shown in FIG. 17 may be configured to locally concentrate electrical signals supplied to the LEDs with short-reach metal lines supplying input signals IO1 to IO3 within the coverage area of this site. In one example, each of MOSFETs T1 to T3 may be relatively large to supply relatively high current to the corresponding LED.

The foregoing disclosure provides illustration and description but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus, comprising:
a substrate;
a plurality of body portions spaced from one another in a cavity within the substrate, each of the plurality of body portions including a corresponding one of a plurality conduits, one of the plurality of conduits including a plurality of optical paths, the plurality of body portions being configured within the cavity to facilitate circulation of a coolant in the cavity;
a first plurality of opto-electronic devices, each of which being provided at a first end of a respective one of the plurality of optical paths; and
a second plurality of opto-electronic devices, each of which being provided at a second end of a respective one of the plurality of optical paths, such that optical signals carrying data are transmitted via the plurality of optical paths, said one of the plurality of conduits extending between the first plurality of opto-electronic devices and the second plurality of opto-electronic devices.

2. The apparatus of claim 1, wherein the substrate has a first side and a second side opposite the first side, the apparatus including:
an integrated circuit provided on the first side of the substrate, the integrated circuit being electrically coupled to one of the first plurality of opto-electronic devices.

3. The apparatus of claim 1, wherein the substrate has a first side and a second side opposite the first side, the apparatus including:
a first plurality of integrated circuits provided on the first side; and
a second plurality of integrated circuits provided on the second side, the first plurality of integrated circuits being electrically coupled to at least one of the first plurality of opto-electronic devices and the second plurality of integrated circuits being electrically coupled to at least one of the second plurality of opto-electronic devices.

4. The apparatus of claim 1, wherein the substrate has a first side and a second side opposite the first side, the apparatus including:
a first plurality of integrated circuits provided on the first side; and
packaged optics provided on the second side.

5. The apparatus of claim 4, further including optical fibers optically communicating with the packaged optics.

6. The apparatus of claim 1, wherein the substrate further includes an inlet operable to receive the coolant and an outlet operable to output the coolant.

7. The apparatus of claim 1, wherein each of the plurality of conduits includes an air-filled space.

8. The apparatus of claim 1, wherein the coolant is water.

9. The apparatus of claim 1, wherein each of the plurality of optical paths includes an optical waveguide.

10. The apparatus of claim 9, wherein the optical waveguide includes polyimide.

11. The apparatus of claim 1, wherein each of the plurality of optical paths includes a passage having a sidewall, the apparatus including a reflective material deposited on the sidewall.

12. The apparatus of claim 1, wherein each of the first plurality of opto-electronic devices includes a corresponding one of a plurality of optical sources.

13. The apparatus of claim 12, wherein each of the plurality of optical sources includes a light emitting diode (LED).

14. The apparatus of claim 12, wherein each of the second plurality of opto-electronic devices includes a corresponding one of a plurality of photodiodes.

15. The apparatus of claim 13, wherein further including a control circuit that controls each of the plurality optical sources to thereby output the optical signals.

16. The apparatus of claim 15, wherein the control circuit includes a plurality of transistors.

17. The apparatus of claim 16, wherein each of the plurality of transistors is coupled to a corresponding one of the plurality of optical sources.

18. The apparatus of claim 17, wherein each of the plurality of transistors is a metal-oxide-semiconductor (MOS) transistor.

19. The apparatus of claim 1, wherein each of the plurality of the plurality of optical paths included in each of the plurality of conduits includes an optical fiber.

20. An apparatus, comprising:
a substrate, the substrate including a cavity;
a first plurality of opto-electronic devices, each of which being provided on a first side of the substrate;
a second plurality of opto-electronic devices, each of which being provided on a second side of the substrate opposite the first side of the substrate;
a plurality of lenses operable to direct optical signals output from a corresponding one of the first plurality of opto-electronic devices through the cavity to a respective one of the second plurality of opto-electronic devices.

21. The apparatus of claim 20, wherein each of the first plurality of opto-electronic devices includes a corresponding one of a plurality of optical sources.

22. The apparatus of claim 21, wherein each of the plurality of optical sources includes a light emitting diode (LED).

23. The apparatus of claim 20, wherein each of the second plurality of opto-electronic devices includes a corresponding one of a plurality of photodiodes.

24. An apparatus, comprising:
a substrate;
a conduit provided in the substrate, a first optical path extending through the conduit, a space surrounding the conduit in the substrate, such that the space is configured to facilitate circulation of a coolant about the conduit;
a first of opto-electronic device provided adjacent a first end of the first optical path;
a mirror provided adjacent a second end of the first optical path;
a second optical path extending laterally relative to the first optical path, a first end of the second optical path being adjacent the mirror; and
a second opto-electronic device being provided adjacent a second end of the second optical path, such that the first optical path, the mirror, and the second optical path facilitate optical transmission between the first and second opto-electronic devices.
